(19) United States
(12) Patent Application Publication
(10) Pub. No.: US 2008/0048858 A1
(43) Pub. Date: Feb. 28, 2008

(54) SEATBELT FAULT ALERT SYSTEM

(76) Inventors: Jacquelynn R. Lueth, Encino, CA (US); William Garnet, Encino, CA (US)

Correspondence Address: MICHAEL A. O'NEIL, P.C., 5949 SHERRY LANE, SUITE 820, DALLAS, TX, 75225, US

(21) Appl. No.: 11/840,287

(22) Filed: Aug. 17, 2007

Related U.S. Application Data
(60) Provisional application No. 60/823,521, filed on Aug. 25, 2006.

(51) Int. Cl. G08B 21/00

(52) U.S. Cl. 340/540

(57) ABSTRACT

A seatbelt fault indicator is activated whenever a seat within a vehicle is occupied but the seatbelt associated with the occupied seat is either not latched or not tensioned.

### CROSS-REFERENCE TO RELATED APPLICATION

Applicant claims priority based on provisional patent application serial number 60/823,521 filed Aug. 25, 2006, the entire content of which is incorporated herein by reference.

### TECHNICAL FIELD

This invention relates generally to vehicular safety, and more particularly to a system for alerting law enforcement personnel that at least one occupant of a vehicle is not properly utilizing his or her seatbelt.

### BACKGROUND AND SUMMARY OF THE INVENTION

Vehicular passenger restraint systems commonly referred to as seatbelts have been in L widespread use since the mid-1960s and have long since been mandated in all cars and light trucks. The function of a seatbelt is to prevent passengers from coming into contact with interior surfaces of the vehicle in which they are riding and/or being thrown from the vehicle in the event of an accident.

The effectiveness of seatbelts in preventing injury or death resulting from an automobile accident is now universally understood. Nevertheless, many automobile and light truck drivers and passengers fail to engage their seatbelts when entering a vehicle. Governmental efforts to correct this problem, including the current “Click It Or Ticket” campaign, have largely been unsuccessful.

The present invention comprises a system for alerting law enforcement personnel that one or more occupants of an automobile or light truck has not properly engaged his or her seatbelt. In accordance with the broader aspects of the invention, if any seat within a vehicle is occupied but the seatbelt associated with the occupied seat is not properly engaged a seatbelt fault signal is transmitted from the vehicle. In this manner law enforcement personnel are made aware that one or more occupants of a specific vehicle is not making proper utilization of his or her seatbelt.

In accordance with more specific aspects of the invention, each seat within a vehicle is provided with three sensors. The first sensor determines whether or not the seat is occupied. The second sensor determines whether or not the seatbelt associated with the seat is latched. The third answer determines whether the seatbelt associated with the seat is tensioned. If the seat is occupied and either the seatbelt is not latched or the seatbelt is not tensioned, a seatbelt fault light situated at the rear of the vehicle is illuminated. Alternatively, a seatbelt fault signal is electronically transmitted to law enforcement personnel.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view diagrammatically illustrating the interior of an automobile equipped with the present invention;

FIG. 2 is a logic tree describing the operation of the invention;

FIG. 3 is a perspective view further illustrating the automobile of FIG. 1 and in particular the seatbelt fault lamp component thereof; and

FIG. 4 is a perspective view illustrating an alternative seatbelt fault signaling system.

### DETAILED DESCRIPTION

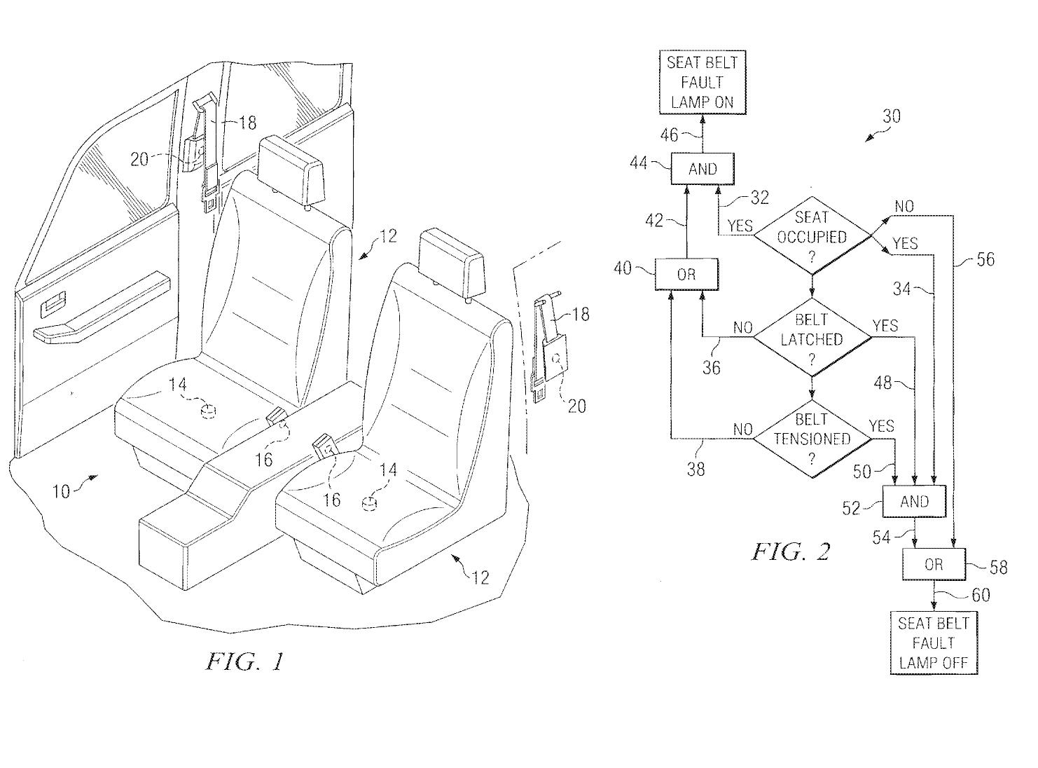

Referring now to the drawings, and particularly to FIG. 1 thereof, there is illustrated the interior of a vehicle 10 equipped with seatbelt fault alert system. The vehicle 10 is equipped with one or more seats 12 which are positioned within the vehicle 10 for use by the driver and the passengers thereof. Although two seats 12 are illustrated in FIG. 1, it will be understood that the invention is not limited to vehicle comprising any particular number of seats. To the contrary, the invention is applicable to vehicles comprising one seat intended for use by the driver of the vehicle through and including twelve or more seats.

In accordance with the invention each seat 12 comprising the vehicle 10 is provided with three sensors. A first sensor 14 determines whether or not a particular seat is occupied. A second sensor 16 determines whether or not a seatbelt 18 associated with the seat is latched. A third sensor 20 determines whether or not the seatbelt 18 associated with the seat is tensioned. As will be appreciated by those skilled in the art, the seatbelt tension sensor 20 functions to present misuse of the present invention by allowing a passenger to engage the seatbelt latch without properly securing the seatbelt around his or her body.

FIG. 2 comprises the logic tree 30 of the present invention. If a particular seat within a vehicle is occupied, the sensor 14 activates lines 32 and 34. If the seatbelt associated with the occupied seat is not latched, line 36 is activated. If the seatbelt associated with the occupied seat is not tensioned line 38 is activated.

If either line 36 or line 38 activated an OR gate 40 activates line 42. If lines 32 and 42 are both activated an AND gate 44 activates a line 46 which in turn activates a seatbelt fault lamp associated with the vehicle.

As indicated above a particular seat within a vehicle is occupied line 34 is activated. If the seatbelt associated with the occupied seat is latched line 48 is activated. If the seatbelt associated with the occupied seat is also tensioned line 50 is activated. Whenever lines 34, 48 and 50 are simultaneously activated an AND gate 52 activates line 54.

If a particular seat within a vehicle is not occupied line 56 is activated. If either line 54 or line 56 is activated an OR gate 58 is activated thereby producing an output on line 60 which turns the seatbelt fault lamp off.

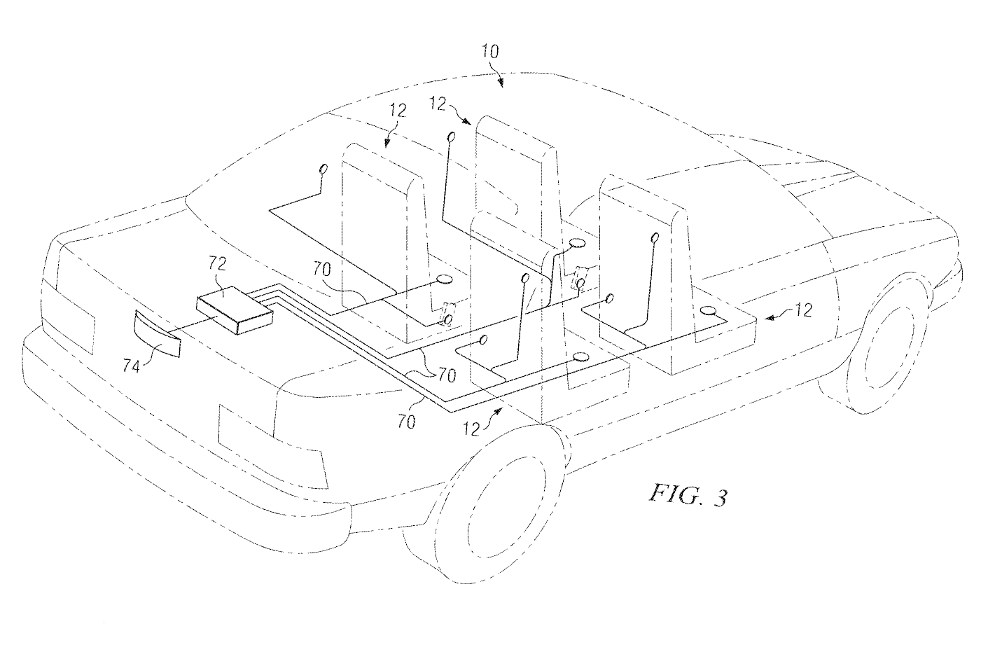

FIG. 3 further illustrates the vehicle 10. Cables 70 extending from the sensors 14, 16, and 20 associated with each of the seats 12 comprising the vehicle 10 extend to a control box 72 which regulates the operation of a seatbelt fault lamp 74.

The seatbelt fault lamp 74 preferably comprises a color not commonly used in automotive applications including the colors red, amber, and white. For example, the color of the seatbelt fault lamp 74 could be green, blue, purple, etc. The shape of the seatbelt fault lamp 74 is preferably markedly different from the lamp shapes commonly employed in automobile applications including round, oval, rectangular, and square. For example, seatbelt fault lamp 74 can be star shaped, hexagonally shaped, octagonally shaped, etc. Lastly, operation of the seatbelt fault lamp 74 may be either continuously or intermittent. The seatbelt fault lamp 74 can take the form of a high intensity, rapidly blinking strobe light which is readily identifiable even in conditions of bright sunlight.

The purpose of the present invention is to activate the seat-belt fault lamp 74 whenever one of the seats 12 comprising a vehicle 10 is occupied and either the seatbelt 18 associated with the occupied seat is not latched or the seatbelt 18 is latched but not tensioned. A public safety official such as a policeman is alerted by actuation of the seatbelt fault lamp 74 and takes appropriate action, typically pulling over the vehicle 10 and issuing a citation. Other appropriate responses by public safety officials to actuation of the seatbelt fault lamp 74 will readily suggest themselves to those skilled in the art.

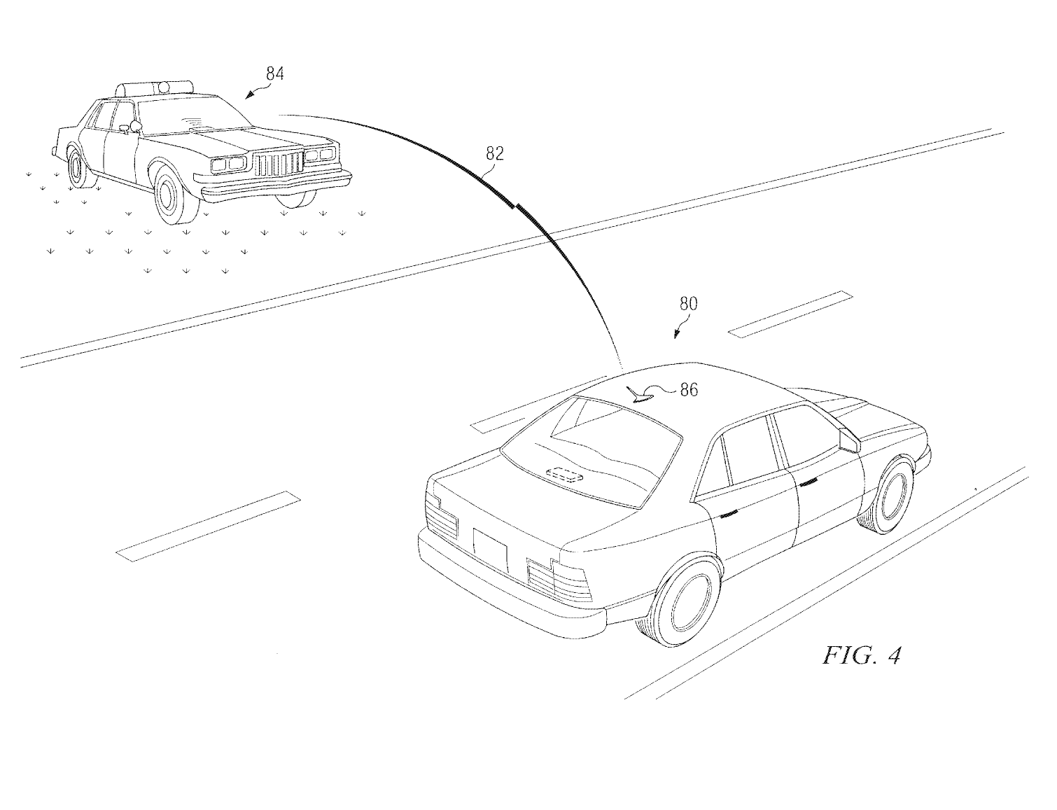

FIG. 4 illustrates a seatbelt fault alert system 80 comprising a second embodiment of the invention. The seatbelt fault alert system 80 is identical to the seatbelt fault alert system 10 illustrated in FIGS. 1-3 and described hereinabove in conjunction therewith except that in lieu or the seatbelt fault lamp 74 the system 80 transmits an electronic signal 82 alerting law enforcement personnel situated in a police car 84 or elsewhere that a seatbelt fault exists. FIG. 4 illustrates the seatbelt fault signal 82 emanating from an antenna 86 of the type utilized to receive satellite signals and the like. However, as will be appreciated by those skilled in the art, various types and kinds of currently available electronic signal transmission devices may be utilized in the practice of the invention. Furthermore, the seatbelt fault signal 82 may be transmitted from any appropriate location on the vehicle in accordance with the requirements of particular applications of the invention.

The seatbelt fault signal 82 preferably comprises one of the numerous frequencies reserved for use by law enforcement personnel. The signal 82 is preferably directional in nature thereby enabling law enforcement personnel to quickly and easily locate the vehicle from the signal 82 is transmitted.

The seatbelt fault signal 82 can also be transmitted utilizing existing technologies including the “ON-STAR”® technology available on vehicles manufactured by General Motors Corporation and the “BLUETOOTH”® technology available on various currently available vehicles. These and similar technologies can be utilized to transmit the seatbelt fault signal to police headquarters or other police dispatch facilities which in turn dispatch the nearest available police officer to address the problem raised by the seatbelt fault signal.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. In combination with a vehicle having at least one seat and a seatbelt associated with the seat, the improvement comprising:
means for determining that the seat of the vehicle is occupied;
means for determining that the seatbelt associated with the seat of the vehicle is not latched;
means for determining that the seatbelt associated with the seat of the vehicle is not tensioned;
a seatbelt fault indicator; and
means responsive to a determination that the seat of a vehicle is occupied and that the seatbelt associated with the seat of the vehicle is either not latched or not tensioned for activating the seatbelt fault indicator.

2. The improvement according to claim 1 wherein the seatbelt fault indicator comprises a lamp.

3. The improvement according to claim 1 wherein the seatbelt fault indicator comprises an electronic signal transmitting device.
